(19) United States
(12) Patent Application Publication
(10) Pub. No.: US 2002/0162216 A1
(43) Pub. Date: Nov. 7, 2002

(54) Equipment for fitting out flexible printed circuits

(76) Inventor: Walter Gratzer, Einsiedeln (CH)

Correspondence Address: Jay A. Bondell, Esq., SCHWEITZER CORNMAN GROSS & BONDELL LLP, 292 Madison Avenue, New York, NY, 10017, US

(21) Appl. No.: 10/140,649

(22) Filed: May 7, 2002

(30) Foreign Application Priority Data
May 7, 2001 (EP) 01 810443.0

(51) Int. Cl. B23P 19/00

(52) U.S. Cl. 29/650

(57) ABSTRACT

Equipment for the automated affixation of contacts and contact housings to segments of flexible printed circuits includes a holding device which holds the segment and raises the segment up from a starting position in the plane of the flexible printed circuit. The segment is firmly retained during processing when a contact is applied and a housing mounted. After processing, the segment is returned to approximately its starting position. Detectors may be used to position the holding device as appropriate to process a desired segment which may be rotated upwardly along a circular guide into the processing position.

The invention relates to equipment for fitting out a flexible printed circuit with at least one segment comprising at least one conductor end, wherein the segment is part of the flexible printed circuit and can be raised up for processing.

### BACKGROUND OF THE INVENTION

Flexible printed circuits (FPCs) consist of at least one layer of electrically insulating material and at least one layer of electrically conductive material. Copper, which is mounted on a base film, is usually used as the electrically conductive material. The production of conductor tracks or paths is usually carried out by means of a chemical process. The copper surface required for the conductor tracks is covered. The unprotected copper surface is subsequently removed, for example, by means of an etching process. Complex conductor track arrangements and minimal conductor track spacings can be made by this production technique. Connection with the conductor tracks is made by means of, for example, a soldering technique or a crimping technique. In the case of a soldered connection, solder with a low melting point connects, under the action of heat, the copper of the conductor track with, for example, a contact leg of a plug. In the case of a crimp connection, the contacts are mechanically connected with the conductor track.

At the end of at least one conductor track the flexible printed circuit may be slit or slotted at the sides and at the end of the conductor track or tracks (the loose part with the conductor track ends is termed a “segment”). A contact is connected with the conductor track by means of a crimping process at the now freely movable conductor track end. In that case claws of the contact pierce the flexible printed circuit in a piercing process and are bent over on the rear side of the flexible printed circuit in a crimping process. The contact is fixedly connected with the flexible printed circuit by the plastic deformation of the claws, whereby the electrical transfer between conductor track and contact is guaranteed. After application of the contact or contacts to the freely movable conductor track ends or segments the contact or contacts are plugged or inserted into a housing.

Semi-automatic equipment which apply the contacts to the conductor tracks and fit the contacts with housings are known from the state of the art. The flexible printed circuits bearing the conductor tracks are fed individually or from rolls, wherein the segments are previously slotted. The segments are manually raised up and fed to the crimping process. After processing, the segment is brought back approximately into the original position.

The productivity of the entire installation is limited by the manual feed of the segments.

The present invention has an object of avoiding the disadvantages of the known equipment and of creating equipment by means of which the processing of flexible printed circuits can be undertaken more efficiently, avoiding manual positioning of segments to be fitted with contacts.

### BRIEF DESCRIPTION OF THE INVENTION

In accordance with the invention, a device for processing flexible printed circuits having at least one segment includes a holding device which raises the segment, firmly holds the segment for processing, and returns the segment to the starting position after processing.

The advantages achieved by the invention are essentially to be seen in that productivity can be increased and printed circuit quality can be improved. The device according to the invention is arranged above a support carrying the flexible conductor track and necessary for the transport of the conductor track. Passages in the support are not necessary for the handling of the flexible printed circuits. Due to the smooth support free of passages, neither scratches nor damage to the flexible printed circuit can arise during transport.

### BRIEF DESCRIPTION OF THE DRAWINGS

The present invention is explained in more detail in the following description and accompanying figures, in which:

FIG. 1 is a perspective view of a detail of a flexible printed circuit with segments;

FIG. 2 is a perspective view of equipped segments of the printed circuit;

FIG. 3 is a detail perspective view of a segment rear side with equipped contacts;

FIG. 4 is a detail perspective view of a segment conductor side with equipped contacts;

FIG. 4a is a detail perspective view of strip-connected contacts before the installation;

FIG. 5 is a plan view of equipment in according with the invention for fitting out a flexible printed circuit with segments;

FIG. 6 is a perspective view of a crimping press for equipping a segment with contacts;

FIG. 7 is an elevation view of a housing equipping means for fitting the contacts with a housing and a holding device for holding the segment to be equipped;

FIG. 8 shows a variant of arrangement of the holding device;

FIG. 9 is a plan view of the holding device before the raising-up of a segment; and

FIG. 10 is an elevation view of the holding device when holding the segment during the equipping process.

### DETAILED DESCRIPTION OF THE INVENTION

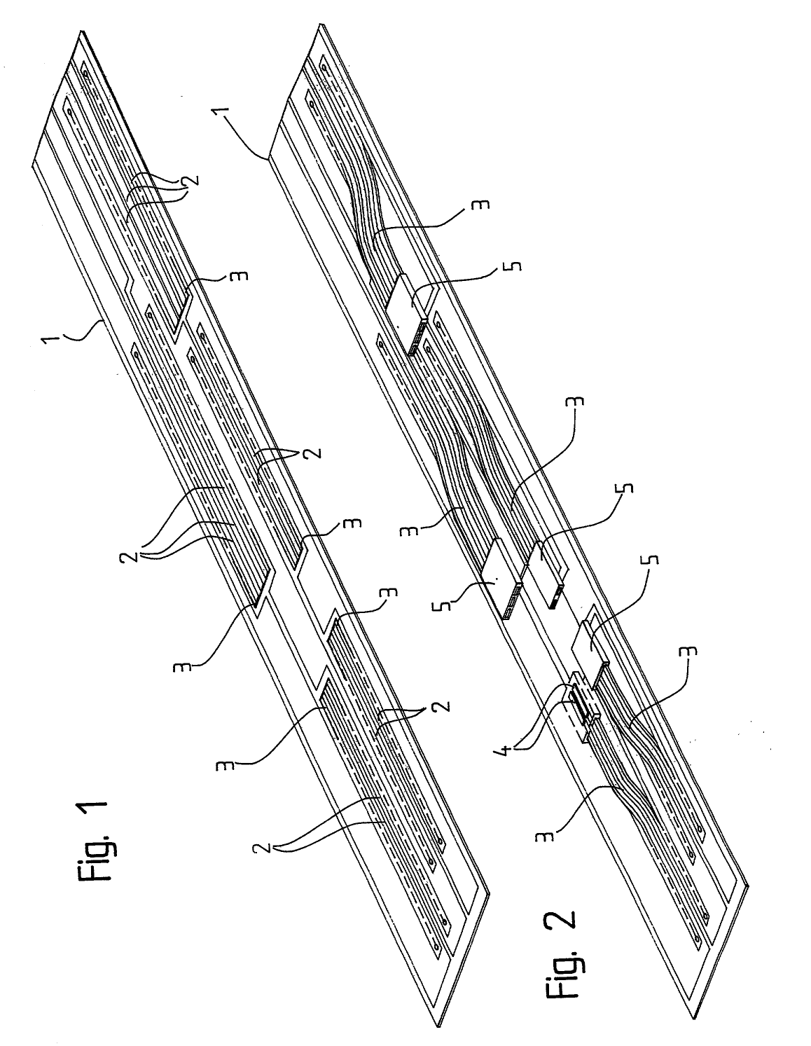

FIG. 1 shows a detail of a flexible printed circuit 1 with electrical conductor tracks 2. At the end of at least one conductor track 2 the flexible printed circuit 1 is slit or slotted laterally and at the end of the conductor track 2. The freely movable part with the conductor track ends, also termed a segment, is denoted by 3.

FIG. 2 shows equipped segments 3 of the flexible printed circuit 1. Electrical contacts 4 are connected by means of a crimping process with the conductor tracks 2 at the freely movable conductor track ends, wherein the contacts 4 are fitted into housings 5.

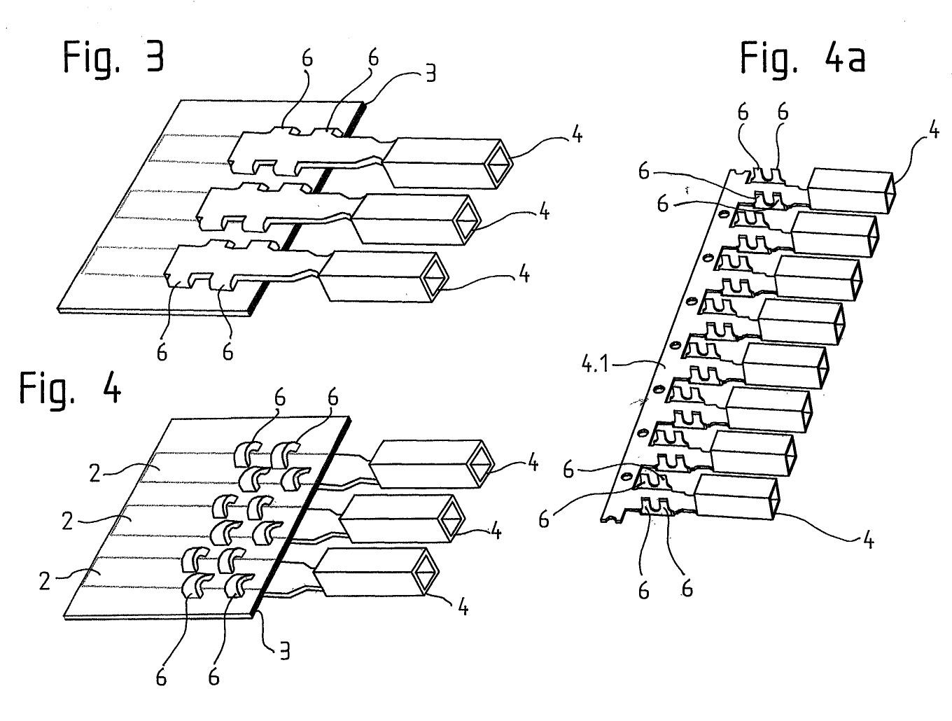

FIG. 3 shows a segment rear side with fitted contacts 4, wherein each contact 4 is provided with claws 6. The claws 6 of the contact 4 pierce in a piercing process the flexible printed circuit 1 and are, as shown in FIG. 4, bent over on the conductor side of the flexible printed circuit 1 in a crimping process. The claws 6 pierce the flexible printed circuit 1 near the conductor tracks 2 and are bent over onto the conductor tracks 2. Contacts can also be provided, the claws of which pierce the conductor tracks. By virtue of the plastic deformation of the claws 6 the contact 4 is fixedly connected with the flexible printed circuit 1, whereby the electrical transfer between conductor track 2 and contact 4 is guaranteed.

FIG. 4a shows a belt product or strip-connected contacts 4 before the fitting. The strip-connected contacts 4 are available for the crimping process from rolls and are separated from the tape portion 4.1 before crimping.

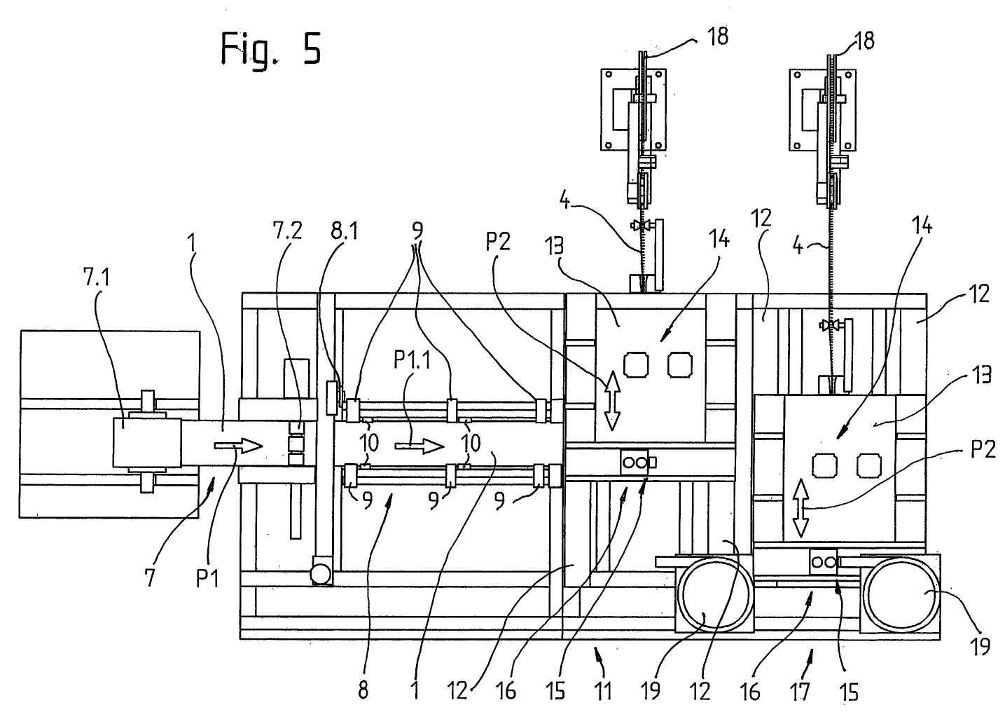

FIG. 5 shows a plan view of equipment for fitting out a flexible printed circuit 1 having segments 3. The flexible printed circuit 1 is fed in the arrow direction P1 in an inlet station 7 from a roll 7.1 by means of draw-off rollers 7.2 to a draw-off station 8, which has a cutting device 8.1 at its entrance. The cutting device 8.1 cuts the flexible printed circuit 1 to the desired length or to the desired panel.

The panel is transported in the arrow direction P1.1 to a first processing station 11 by means of holding grippers 9, which serve as a guide and holder, and transport grippers 10, which serve as advancing means. As shown in FIG. 5, holding grippers 9 and transport grippers 10 are arranged on both sides of the panel to be transported. Holding grippers 9 and transport grippers 10 can also be arranged on only one side of the panel. In the first processing station 11 the segments 3 are raised up and provided with contacts 4, which are plugged into a housing 5 per segment 3. A crimping press 14 and a housing equipping means 15 are arranged at a first platform 13 movable in the arrow direction P2 along first linear axles 12. The drive for the first platform 13 is not illustrated. A holding device 16 arranged below the first platform 13 raises the segments 3 up from the flexible printed circuit 1, firmly holds the segments 3 during the processing and thereafter brings the segments 3 back into their original position. The crimping press 14 is supplied with contacts 4, which are available in strip-connected form from rolls 18. A housing bin 19 keeps a supply of the housings 5 ready for the housing equipping means 15.

In a further processing station 17, segments 3 may be fitted with contacts different from the contacts 4 of the first processing station 11. A further processing station is provided for each kind of contact or orientation of the segment to be equipped, wherein the processing stations are comparable in construction. The housing equipping means 15 of the further processing station 17 similarly receives housings 5 from the corresponding housing bin 19. After the last processing station, there is provided an outlet station which stacks and delivers the fitted-out panels.

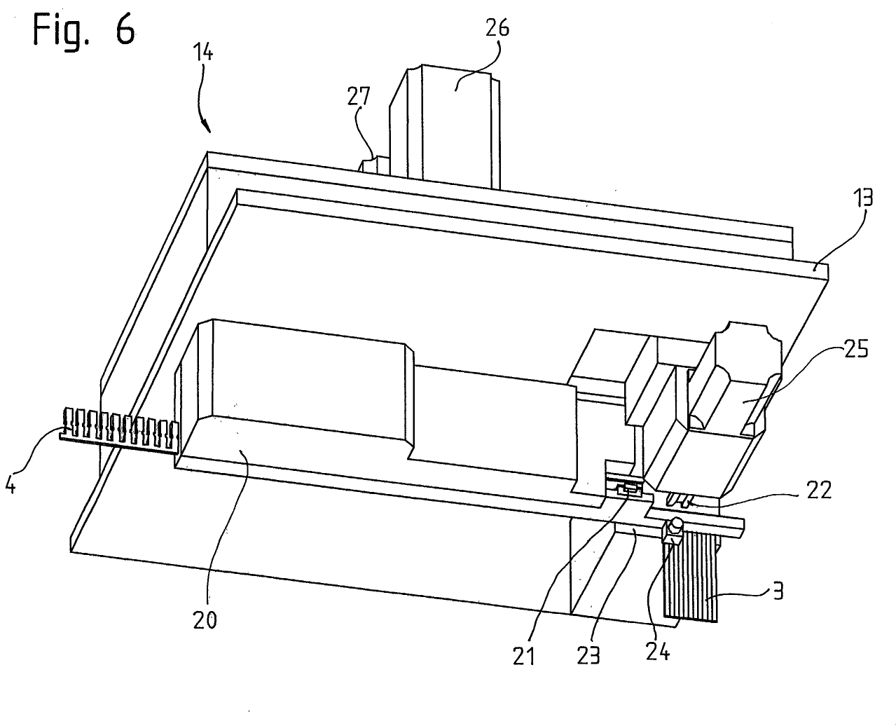

FIG. 6 shows schematically the crimping press 14 for equipping a segment 3 with contacts 4. The contacts 4 are fed in strip-connected form to a first feeder 20 which separates the contacts 4 by means of a knife 21. An upper crimping die 22 picks up the contacts 4 individually and equips the segment 3 held by means of the holding device 16, wherein the claws 6 pierce the segment 3 and are bent over onto the conductor track 2, as shown in FIG. 4, by means of a lower crimping die 23. Before the equipping, the first platform 13 has been positioned on the segment 3 by means of a first detector scanning the edge of the segment 3. A second detector 24 scans at least the first conductor track 4 of the segment 3 and positions the upper crimping die 22 and the lower crimping die 23 on the conductor track 2 to be equipped. A first drive 25 is provided for crimping movement of the upper crimping die 22. A second drive 26 positions the upper crimping die 22 and the third drive 27 positions the lower crimping die 23 on the conductor track 2 to be equipped.

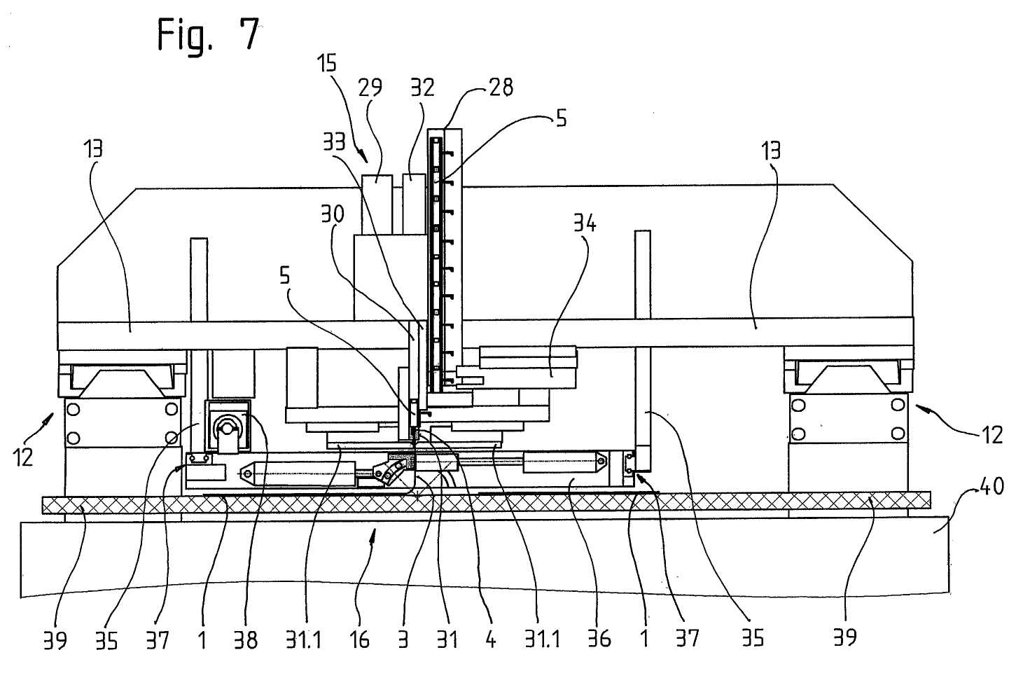

FIG. 7 shows the housing equipping means 15 for fitting at least one contact 4 with a housing 5 and the holding device 16 for holding the segment 3 to be equipped. The housing equipping means 15 is arranged at the first platform 13, which is movable along the first linear axles 12 transversely to the transport direction of the flexible printed circuit 1. The linear axles 12 are supported on a fixed support 40 and at least one linear axle 12 is provided with a linear drive, which is not illustrated. The housings 5 are stored in a first housing tube or shaft 28, wherein the housings 5 are dispensed from the housing bin 19. The contacts 4 arranged in the raised-up segment 3 are aligned and held by means of a positioning plate 31.1, wherein an adjustable double-sided comb embraces the contacts. A first ram 30 driven by means of a first cylinder 29 pushes a housing 5, which is stored in a second housing shaft 31, over the contacts of the segment 3 held by means of the holding device 16. Thereafter a second ram 33 driven by means of a second cylinder 32 closes the housing 5. After retraction of the rams 30, 33 the second housing shaft 31 is free for reception of a further housing 5, which is transported into the housing shaft 31 by means of a second feeder 34.

Carriers 35, which carry a second platform 36, are arranged at the first platform 13. The platform 36 is mounted to be displaceable along second linear axles 37, wherein a second linear drive 38 moves the second platform 36. The second platform 36, movable transversely to the direction of transport of the flexible printed circuit 1, serves as a carrier for the holding device 16, which is arranged above a support 39 carrying the flexible printed circuit 1. During the equipping process the second platform 36 executes a counter-movement relative to the movement of the first platform 13, wherein the holding device 16 remains stationary relative to the flexible printed circuit 1. When the first platform 13 moves for driving the crimping press 14 or the housing equipping means 14 up to the segment 3 to be equipped, the holding device 16 remains stationary.

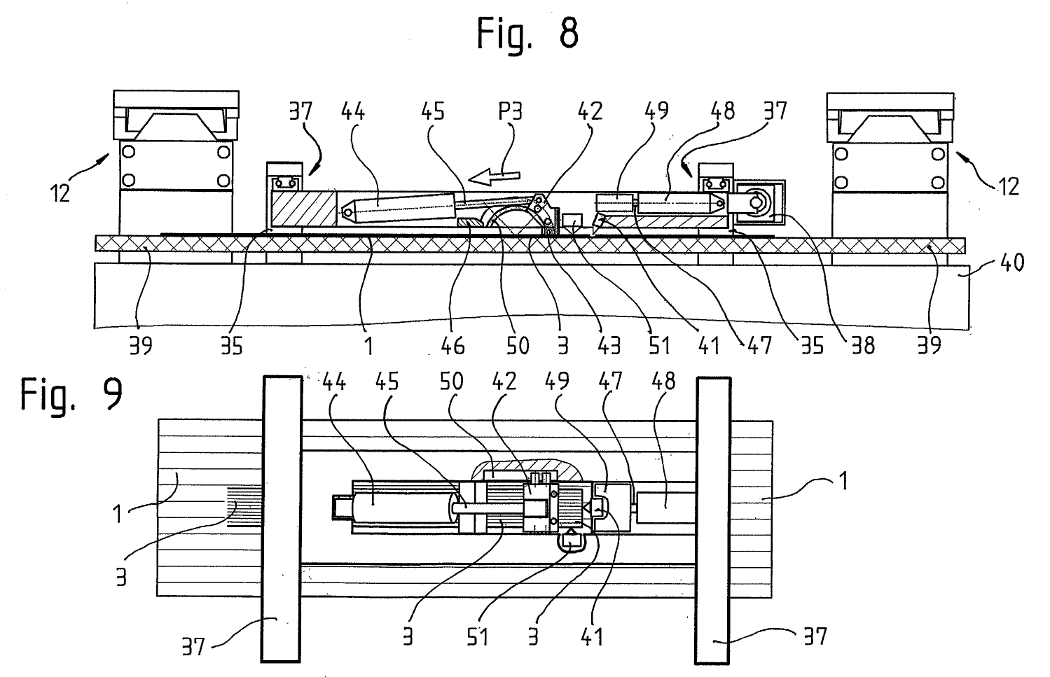

FIGS. 8, 9 and 10 show a variant arrangement of the holding device 16. The second platform 36 is not, as shown above, connected with the first platform 13. The carriers 35 of the second platform 36 are supported on the fixed support 40. The second platform 36 together with the holding device 16 is positioned on the segment 3 to be equipped and then remains stationary during the equipping process.

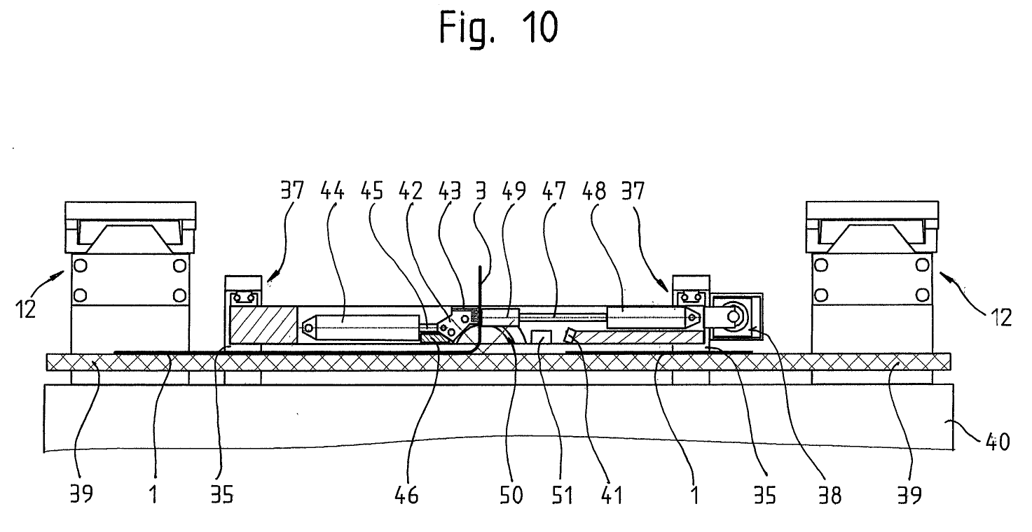

FIG. 8 and FIG. 9 show the holding device 16 before the raising-up of a segment 3. A third detector 41 scans the end edge of the segment 3 and stops the advance of the flexible printed circuit 1. A fourth detector 51 scans the side edge of the segment 3 and positions the holding device 16 in the transverse direction relative to the flexible printed circuit 1 on the segment 3 to be equipped. A vacuum gripper 43 arranged at a slide 42 grips the segment 3 as vacuum is applied to the vacuum gripper 43. A third cylinder 44 executes, by its piston rod 45, a movement in the arrow direction P3, rotating the slide 42 along a circular guide 50 through 90° up to abutment 46, whereby the segment 3 is raised up. A piston rod 47 of a fourth cylinder 48 is then driven out, whereby the piston rod 47 presses a die 49 onto the rear side of the segment 3 against the vacuum gripper 43. The segment 3 is now, as shown in FIG. 10, firmly held between vacuum gripper 43 and die 49 until the equipping process is concluded. Thereafter the die 49 is retracted, the slide 42 rotated back through 90° by means of the third cylinder 44 and the vacuum gripper 43 detached as pressure is applied to the vacuum gripper 43. The equipped segment 3 is then again in the approximate starting position.

The two lefthand segments 3 of the printed circuit 1 shown in FIG. 1 can be raised up by the orientation of the holding device 16 shown in FIGS. 7 to 10. The raising up takes place in the anticlockwise sense. The remaining segments 3 of the printed circuit 1 shown in FIG. 1 have to be raised up in clockwise sense. For that purpose the holding device 16 is so oriented in the respective processing station that the slide 42 executes a movement in the clockwise sense.

The above-explained processing of the segment 3 comprises the equipping of the segments 3 with contacts 4 and the fitting of the contacts 4 with housings 5. The holding device 16 for raising up the segments 3 can also be used for other operations, such as, for example, cleaning the conductor tracks, preparing the conductor tracks for the soldering process, producing soldered connections or application of bores or punchings to the segments 3 and/or to the conductor tracks 2 of the segments 3.

I claim:

1. Equipment for fitting out a flexible printed circuit having at least one segment comprising at least one conductor end, wherein the segment can be raised up for processing, characterised in that for handling the segment there is provided a holding device which raises the segment up from a starting position at the flexible printed circuit, firmly holds the segment for processing and returns the segment approximately into the starting position after the processing.

2. The equipment according to claim 1, characterised in that the holding device is arranged above a support carrying and transporting the flexible printed circuit.

3. The equipment according to claim 1 or 2, characterised in that the holding device is arranged at a second platform, which is movable transversely relative to a transport direction of the flexible printed circuit.

4. The equipment according to claim 3, characterised in that the second platform is movable along second linear axles, which are arranged at a first platform movable transversely to the transport direction of the flexible printed circuit.

5. The equipment according to claim 3, characterised in that the second platform is movable along second linear axles which are arranged at a fixed support.

6. The equipment according to claim 3, characterised in that arranged at the second platform are detectors which detect edges of the segment and position the holding device on the segment.

7. The equipment according to claim 6, characterised in that for gripping the segment the holding device comprises a vacuum gripper which is rotatable for raising up the segment, and a die for pressing the segment against the vacuum gripper when the segment is raised up.

8. The equipment according to claim 7, characterised in that the vacuum gripper and the die are movable by means of cylinders and the vacuum gripper is guided in a circular guide.

9. Equipment for fitting out a flexible printed circuit having at least one segment comprising at least one conductor end, wherein the segment can be raised up for processing, comprising at least one processing station for processing the at least one segment in at least one working step and a holding device for raising up and holding the segment during the processing.

10. The equipment according to claim 9, characterised in that the processing station comprises a crimping press for equipping the at least one segment with at least one contact and a housing equipping means for fitting the at least one contact with a housing.

11. The equipment according to claim 9 or 10, characterised in that the crimping press and the housing equipping means are movable transversely to a transport direction of the flexible printed circuit, the holding device is movable relative to the crimping press, and the housing equipping means is movable transversely to the transport direction of the flexible printed circuit.
